(19) United States
(12) Patent Application Publication
(10) Pub. No.: US 2010/0059549 A1
(43) Pub. Date: Mar. 11, 2010

(54) APPARATUS AND METHOD FOR DOSING OF LIQUIDS IN GAS FILLED SPACES

(75) Inventors: Oliver Bettmann, Florsheim (DE); Ulrich Kathe, Leonberg (DE); Thomas Schipolowski, Stuttgart (DE); Masar Ramizi, Tuttlingen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft für Mess- und Regeltechnik mbH + Co. KG, Gerlingen (DE)

(21) Appl. No.: 12/449,452

(22) PCT Filed: Feb. 13, 2008
(86) PCT No.: PCT/EP2008/051700

§ 371 Date: Nov. 10, 2009

(30) Foreign Application Priority Data
Feb. 13, 2007 (DE) 10 2007 007658.6
Mar. 1, 2007 (DE) 10 2007 010412.1

(51) Int. Cl. G01F 11/28; B01L 3/02; F04B 43/08; B65D 47/18

(52) U.S. Cl. 222/214; 222/1; 417/476; 222/422; 222/207; 222/212

(57) ABSTRACT

An apparatus or dosing of liquids into a gas filled space comprising: a pump; a dosing orifice for introduction of liquid into the gas filled space; a discharge line, which connects a pressure side of the pump with the dosing orifice; and an elastic, liquid storer. The discharge line includes a shutoff valve between the pump and the dosing orifice, wherein the elastic, liquid storer is located between the pump and the shutoff valve, and the apparatus includes a first operating state, in which the pump runs in the case of closed shutoff valve, in order to store in the elastic, liquid storer a liquid amount under pressure.

The present invention relates to an apparatus and a method for dosing of liquids into gas filled spaces. Such methods and apparatuses find application, for example, in analysis technology, wherein analytes or reagents are to be dosed, or metered. The dosing of liquids should generally fulfill the goal of introducing a defined volume of a substance into a target location, for example, a reactor or an analyzer.

Dosing apparatuses for such purpose are composed, usually, of the following components, which are connected with one another and arranged one after the other in the direction of flow: A pump supply line, which is connected with a source; a pump; a pump discharge line; and a dosing orifice. If the dosing orifice opens not into a liquid medium but, instead, into a gaseous medium (e.g. into an air-filled reactor), then the liquid enters into the reactor in the form of a stream or dropwise. In such case, often a releasing of the liquid, in free fall, into a target zone of the reactor is desired, without the liquid contacting the reactor wall.

Due to the often small target amounts of the substance to be dosed, especially in the μl, or lower ml, range, even the last drop must be deposited in a defined manner, in order to reach the target amount with the desired accuracy. If the last drop in a total number of N drops is dosed only with a certain probability, then the relative uncertainty is 1/N. In the case of a total amount corresponding to a volume of, for example, 20 drops, this uncertainty would mean a relative inaccuracy of 5%. This is, in many cases, not acceptable. The question, whether a drop is included in the dosing, thus whether it is released from the dosing orifice, depends on the particular circumstances—thus, for example, on drop size, viscosity, surface tension, dosing velocity, as well as geometry of the dosing orifice. Moreover, random vibrations or shaking can be the final factor leading to release. As a result, the question of whether the last drop is dosed is, more or less, a matter of chance.

Particularly from laboratory practice or chemical technology, different techniques are known for dosing the last drop controllably.

In the case of pipetting, it is possible to dose first into a target receptacle, and, at least toward the end of the dosing, to hold the pipette tip against the inner wall of the target receptacle, in order that the surface energy of the inner wall facilitates the release of the last drop. This procedure is, on the one hand, only conditionally amenable to being automated and is totally unusable, when the substance to be dosed should fall into the target receptacle in free fall, thus without contacting the wall of the target receptacle.

Furthermore, the substance to be dosed can be blown into a target receptacle with a greater volume of a carrier gas, for example, using a piston-driven pipette. Disadvantageous, here, is the uncontrolled wetting of surfaces in the target receptacle, which can, especially over long periods of operation, lead to instances of carryover and to poor reproducibility. Additionally, based on the compressibility of the carrier gas, a pressure dependence of the dosing accuracy is present, which requires a greater complexity as regards sensors.

Finally, the dosing can occur through a nozzle, for instance an injection nozzle, with increased velocity. This procedure is, per se, not bad, but it cannot be implemented with a peristaltic pump, since these do not create the required pressure. Nozzles cannot be used, additionally, in the case of particle-containing liquids, because of the danger of plugging.

An object of the invention, therefore, is to provide a simple and exactly working, dosing apparatus, which, especially, includes the opportunity of using a peristaltic pump, and which, especially, is suitable for methods, which require a dropwise dosing of samples or reagents into a reaction vessel, wherein, for example, the allowable deviation from the desired value is smaller than the volume of a single drop. Furthermore, a corresponding dosing method is provided, which overcomes the aforementioned disadvantages of the state of the art.

The object is achieved according to the invention by the apparatus as defined in independent claim 1 and by the method as defined in independent claim 13.

The apparatus of the invention for dosing of liquids into a gas filled space, for example, a reaction chamber, includes: A pump; a dosing orifice for introduction of liquid into the gas filled space; a discharge line, which connects a pressure side of the pump with the dosing orifice; and a elastic, liquid storer, characterized in that the discharge line has a shutoff valve arranged between the pump and the dosing orifice, wherein the elastic, liquid storer is arranged between the pump and the shutoff valve, wherein the apparatus has a first operating state, in which the pump runs with closed shutoff valve, in order to store in the elastic, liquid storer a liquid amount under pressure.

The apparatus can include a second operating state, in which the pump is turned off in the case of closed shutoff valve with the liquid storer under pressure.

The apparatus includes, furthermore, a third operating state, in which the shutoff valve is opened in the case of turned-off pump, in order to let liquid flow out from the elastic, liquid storer.

Furthermore, the apparatus can include a fourth operating state, in which the shutoff valve is opened in the case of running pump.

Furthermore, the apparatus can include a control unit, which controls the described operating states and the transitions between the operating states. The control unit comprises, preferably, a microprocessor, which is integrated, for example, with the earlier named components in one device; it can, however, as well, comprise an external computer, which communicates with the other components via a data line or wirelessly.

For a defined dosing of a liquid amount, it is important, that the dosing be exact to the drop. When, of a target amount to be dosed, still the volume of a drop, or of a part of a drop, is missing, the apparatus is brought into the first operating state, and held in this state, until the elastic, liquid storer has stored the missing volume under pressure. Then, the apparatus is brought by the control unit from the first operating state, directly one after the other, into the second and third operating states, or directly from the first operating state into the third operating state, whereby the elastic, liquid storer standing under pressure is relaxed by expulsion of the missing liquid volume. In this way, a corresponding liquid volume is ejected at the dosing orifice with such a velocity, that adhesive forces to the dosing orifice are overcome, and a drop portion, on occasion, still clinging at the dosing orifice, is released together with the ejected, missing, liquid volume.

The elastic, liquid storer can be implemented, in the simplest case, by the discharge line, which comprises, for example, an elastic tube of a peristaltic pump. The length of the tube section between pump and shutoff valve is, in such case, to be dimensioned, such that the relative volume increase of the tube by the pumping in of the missing volume, in the case of closed shutoff valve, relative to the equilibrium volume, thus the volume of the relaxed tube section, leads to a sufficient pressure rise, that the missing liquid volume is ejected with a sufficient velocity after opening of the shutoff valve. The volume change from the accommodating of the missing liquid volume relative to the equilibrium volume of the tube section between pump and shutoff valve can lie, for example, between about 5% and about 20%, or between about 10% and about 15%, of the equilibrium volume.

The elastic, liquid storer can be also an elastic container, for example, a bellows, which is in communication with a rigid discharge line. In another embodiment of the invention, the elastic, liquid storer comprises a rigid discharge line, in which a compressible filler is arranged. Similar dimensioning such as used for the case of the elastic tube is to be provided.

The control unit can perform the dosing especially of the missing volume, for example, as a function of time. In such case, pump run times are associated, in the different operating states, in which the pump is operated, especially in the first operating state, with pumped volumes. In another embodiment of the invention, the monitoring of the dosing of the missing volume in the first operating state occurs via a pressure sensor, which monitors the pressure in the elastic, liquid storer, or via a deformation sensor, which monitors, for example, the expansion of an elastic, tubular, discharge line. Finally, also a flow sensor can be used, which monitors the supplied amount.

The shutoff valve can, in a simple embodiment, be embodied as a pinch valve; it is, however, possible to apply any other type of valve. Advantageously, however, the valve is able to open and/or close rapidly. In a currently preferred embodiment, the shutoff valve comprises a magnetically operated, pinch valve, which rapidly closes the supply tube when an electrical current flows through a magnet coil and similarly rapidly opens the supply tube to allow liquid flow, upon the turning off of the electrical current. The term “rapidly” refers here to the time for opening, or closing, of the supply tube compared to the dosing time of the volume of a drop in the case of running pump and opened tube. Accordingly, the opening, or closing, occurs rapidly, when it requires less than 1%, preferably less than 0.5%, and further preferably less than 0.25% of the dosing time of a volume of a drop under the stated conditions.

The dosing orifice can comprise, for example, the opening of a cannula, especially a stainless steel, or glass, cannula. The shutoff valve is preferably located as close as possible to the dosing orifice.

The method of the invention for dosing of liquids into a gas filled space, especially as applied with an apparatus of the invention, includes steps of: Operating a pump, in order to supply a defined liquid amount via a discharge line into an elastic, liquid storer, which, upon accumulating the defined liquid amount, has a defined positive pressure, wherein the discharge line is closed by means of a shutoff valve relative to a dosing orifice, and wherein the elastic, liquid storer is arranged between the pump and the shutoff valve; and opening the shutoff valve with pump turned-off, in order that the liquid storer expels the defined liquid amount, wherein the stored liquid, based on the positive pressure in the elastic, liquid storer, escapes with such a velocity from the elastic, liquid storer, that a corresponding amount of liquid, which issues from the dosing orifice, because of its velocity, overcomes adhesive forces to the dosing orifice, and separates from the dosing orifice.

The time period, for which the pump is operated in the case of closed shutoff valve, is preferably so selected, that a sufficient pressure builds up in the elastic, liquid storer, that, upon opening of the valve, the defined liquid amount escaping at the dosing orifice is expelled in the form of a single drop, which, through the velocity of the escape, separates completely from the dosing orifice, wherein liquid drops, on occasion, clinging to the dosing orifice, are carried along by the escaping liquid.

Before operating the pump in the case of closed shutoff valve, the pump can be operated at the beginning of the dosing in the case of open shutoff valve, in order to output a defined, base volume, before the shutoff valve is closed, wherein the volume pumped into the elastic, liquid storer in the case of closed shutoff valve is a defined remaining volume for completing a total volume.

According to a point of view of the invention, the base volume and the remaining volume can, together, result in, for example, a single drop, which separates from the dosing orifice. The drop produced in this way can, on occasion, be clearly smaller than drops released by ordinary pumps from the dosing orifice. As a result, the method offers an alternative to dosing through narrow nozzles, which, indeed, do also enable the releasing of smaller drops, but which, in the case of liquids carrying solids, can easily become plugged.

In an embodiment of this point of view of the invention, the base volume amounts to no more than 8-times, preferably no more than 4-times, further preferably no more than 2-times, and, especially preferably, no more than 1-times the remaining volume.

In order to dose larger amounts with drops, a target volume can be dosed by alternately repeating the steps for output of the base volume and for dosing the remaining volume, which together, in each case, yield a defined total volume, until the multiple of such total volume equals the target volume.

According to another aspect of the invention, the base volume can comprise the volume of a plurality drops, and the remaining volume can serve, during the escaping with increased velocity, to separate drops possibly remaining on the dosing orifice from the output of the base amount.

The apparatus is especially suitable for dosing of reagents or samples, for example, aqueous samples, in the volume range of μl and ml into reactors of apparatuses for ascertaining analytical parameters, for example, TOC.

The dosing rates can lie, for example, in the range of about 1 to about 10 μl/sec.

In the case of the method for dosing of liquids into a gas filled space, for example, a pump can supply a predetermined volume through an elastic tube to a dosing orifice, with the valve being open from the beginning of the dosing and then being closed shortly before termination of the dosing, while the pump is still running, and, finally, at the point in time, when the pump stops running, the valve is reopened. The time period, in which the valve is closed, is, in such case, so selected, that a sufficient pressure builds up in the elastic tube, such that the remaining amount of the volume to be dosed upon the reopening of the valve is expelled in the form of a single drop, which through the velocity of the escape, completely separates from the dosing orifice.

In an alternative embodiment of the method for dosing of liquids into a gas filled space, wherein a pump supplies a predetermined volume through an elastic tube to a dosing orifice, the valve is periodically closed after the supply of a certain volume, which is smaller than the volume of a single drop in the case of uninterrupted supply, and then reopened. The time period, in which the valve is closed, is, in such case, so selected, that a sufficient pressure builds up in the elastic tube, that the drop formed on the dosing orifice, together with the volume accumulated in the elastic tube, is, upon the reopening of the valve, expelled as a single drop, which, through the velocity of the escape, completely separates from the dosing orifice.

The invention will now be explained on the basis of an example of an embodiment illustrated in the drawing, the sole FIGURE of which shows as follows:

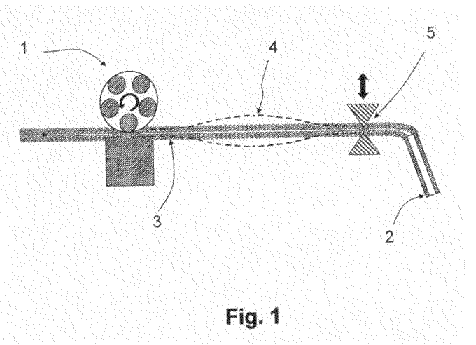

FIG. 1 a block diagram of an apparatus of the invention.

The dosing apparatus shown in FIG. 1 includes a peristaltic pump 1 and a dosing orifice 2 on the end of a several cm long steel cannula having an inner diameter of about 1 mm. Attached to this cannula is the end section of an elastic tube 3, which extends through the peristaltic pump 1, in order to be able to supply a liquid through the tube to the dosing orifice. The tube can be, for example, a BPT tube, such as obtainable from Saint Gobain under the mark PHARMED, for peristaltic pump. In an example of an embodiment of the invention, the inner diameter amounts to about 0.76 mm. The tube can be abruptly closed and reopened in its end section near the cannula with a magnetically controlled, pinch valve 5. The tube serves, at the same time, as an elastic, liquid storer 4, which, in the case of closed pinch valve, can accommodate, under pressure, more liquid than in the relaxed, equilibrium state. In this setting, the controlled dosing and separation of defined drops can be performed, as will now be explained.

In order, for example, to dose a drop of 25 μl one can first supply, by means of the peristaltic pump, 20 μl liquid in the case of opened valve 5. This liquid volume will, with large probability, not separate from the cannula, but, instead, remain as a drop hanging on its end. Following dosing of this base amount, the valve is closed and the remaining 5 μl are supplied into the tube 3 acting as the elastic, liquid storer 4.

The tube section between the pump 1 and the valve 5 has a length of about 9 cm, which corresponds to an equilibrium volume of about 41 μl. The additional 5 μl mean thus an increase of the tube volume by about 12%, or an average elastic expansion of the tube circumference by about 6%. The pressure increase required for expansion of the tube is sufficient, after the turning off of the pump and the opening of the valve, to expel the additional 5 μl so rapidly from the tube, that the corresponding liquid amount flowing out at the dosing orifice 2 is rapid enough to overcome the adhesive forces to the cannula and to separate the earlier supplied 20 μl also.

1-19. (canceled)

20. An apparatus for dosing of liquids into a gas filled space, comprising: a pump;
a dosing orifice for introduction of liquid into a gas filled space;
a discharge line, which connects a pressure side of said pump with said dosing orifice; and
an elastic, liquid storer; wherein:
said discharge line includes a shutoff valve between said pump and said dosing orifice;
said elastic, liquid storer is located between said pump and said shutoff valve; and a first operating state, in which said pump runs in the case of a closed shutoff valve, in order to store in said elastic, liquid storer a liquid amount under pressure.

21. An apparatus as claimed in claim 20, further comprising:
a second operating state, in which said pump is turned off in the case of a closed shutoff valve with said elastic, liquid storer under pressure.

22. An apparatus as claimed in claim 20, further comprising:
a third operating state, wherein:
said shutoff valve is open in the case of a turned-off pump, in order to let liquid flow out of said elastic, liquid storer.

23. The apparatus as claimed in claim 20, further comprising:
a fourth operating state, in which said shutoff valve is open in the case of running of said pump.

24. The apparatus as claimed in claim 20, further comprising:
a control unit, which controls the operating states and transitions between the operating states.

25. The apparatus as claimed in claim 20, wherein:
for defined dosing of a liquid amount, the apparatus can be brought into said first operating state, and held in this state, until said elastic, liquid storer has accommodated a defined volume under pressure; and
the apparatus can then be brought, directly one after the other, into said second and third operating states or directly from said first into said third operating state, whereby said elastic, liquid storer standing under pressure can be relaxed with expulsion of the defined liquid volume.

26. The apparatus as claimed in claim 20, wherein:
said elastic, liquid storer comprises an elastic tube of a peristaltic pump, a bellows, or a compressible filler in a discharge line.

27. The apparatus as claimed in claim 26, wherein:
the length of the tube section between said pump and said shutoff valve is so dimensioned, that a relative volume increase of the tube by pumping in of a defined volume in the case of a closed shutoff valve, relative to the equilibrium volume of the relaxed tube, leads, with a liquid filled tube section, to a sufficient pressure rise that a missing liquid volume, after opening of said shutoff valve, is ejected with a velocity sufficient to separate a drop.

28. The apparatus as claimed in claim 27, wherein:
the relative volume change from the accommodating of the defined liquid volume, with reference to the equilibrium volume of the tube section between said pump and said shutoff valve, amounts to between about 5% and about 20%, or between about 10% and about 15%, of the equilibrium volume.

29. The apparatus as claimed in claim 23, wherein:
said control unit monitors dosing as a function of time.

30. The apparatus as claimed in claim 23, wherein:
said control unit monitors dosing by means of a pressure sensor or by means of a deformation sensor.

31. The apparatus as claimed in claim 26, wherein:
said shutoff valve comprises a pinch valve, which closes an elastic tube of a peristaltic pump.

32. A method for dosing liquids into a gas filled space, comprising the steps of:
operating a pump, in order to supply a defined liquid amount via a discharge line into an elastic, liquid storer, which, upon attaining the defined liquid amount, has a defined positive pressure, wherein the discharge line is closed relative to a dosing orifice by means of a shutoff valve, and wherein the elastic, liquid storer is located between the pump and the shutoff valve; and
opening the shutoff valve in the case of a turned-off pump, in order that the liquid storer expels the defined liquid amount, wherein the stored liquid based on the positive pressure in the elastic, liquid storer, escapes from the elastic, liquid storer with such a velocity, that a corresponding amount of liquid, which escapes from the dosing orifice, based on its velocity, overcomes adhesive forces to the dosing orifice and separates from the dosing orifice.

33. The method as claimed in claim 32, wherein:
a time period, during which the pump is operated in the case of closed shutoff valve, is so selected, that a sufficient pressure builds up in the elastic, liquid storer, that, upon opening of the valve, the defined liquid amount escaping at the dosing orifice is expelled as a single drop, which, through the velocity of the escape, completely separates from the dosing orifice, and
on occasion, liquid drops clinging to the dosing orifice are carried along by the escaping liquid.

34. The method as claimed in claim 32, wherein:
before operating the pump in the case of a closed shutoff valve, the pump is operated at the beginning of the dosing in the case of an open shutoff valve, in order to output a defined base volume, before the shutoff valve is closed, and a volume pumped into the elastic, liquid storer in the case of closed shutoff valve is a defined remaining volume for completing a total volume.

35. The method as claimed in claim 34, wherein:
the base volume and the remaining volume form together a drop, which separates from the dosing orifice.

36. The method as claimed in claim 35, wherein:
the base volume amounts to no more than 8-times, preferably no more than 4-times, further preferably no more than 2-times, the remaining volume.

37. The method as claimed in claim 35, wherein:
for dosing a target volume, alternately the steps for outputting the base volume and for dosing the remaining volume, which, in each case, together result in a defined total volume, are repeated until the target volume is reached.

38. The method as claimed in claim 34, wherein:
the base volume includes the volume of a plurality of drops, and the remaining volume serves, with elevated velocity, to separate drops possibly remaining on the dosing orifice from the output of the base amount.
